(19) United States
(12) Patent Application Publication
(10) Pub. No.: US 2015/0270538 A1
(43) Pub. Date: Sep. 24, 2015

(54) CARBON-SILICON COMPOSITE, AND LITHIUM SECONDARY BATTERY ANODE AND LITHIUM SECONDARY BATTERY INCLUDING THE SAME

(71) Applicant: OCI COMPANY LTD., Seoul (KR)

(72) Inventors: Yo-Seop KIM, Seongnam-si (KR); Eun-Hye JEONG, Seongnam-si (KR); Sung-Ho JUNG, Seongnam-si (KR); Jeong-Hyun HA, Seongnam-si (KR)

(21) Appl. No.: 14/661,292

(22) Filed: Mar. 18, 2015

(30) Foreign Application Priority Data
Mar. 19, 2014 (KR) 10-2014-0032028

(51) Int. Cl. H01M 4/36; H01M 4/62; H01M 4/66; H01M 4/134; H01M 4/133; H01M 4/38; H01M 4/583

(52) U.S. Cl. CPC H01M 4/366; H01M 4/386; H01M 4/625; H01M 4/583; H01M 4/134; H01M 4/133; H01M 4/622; H01M 4/661; H01M 2004/027

(57) ABSTRACT

The present disclosure provides a carbon-silicon composite including: a first carbon matrix; and carbonized Si-block copolymer core-shell particles dispersed uniformly in the first carbon matrix. The present disclosure also provides a lithium secondary battery anode and a lithium secondary battery, which include the carbon-silicon composite.

### CROSS REFERENCE TO RELATED APPLICATION

This application claims the benefit of Korean Patent Application No. 10-2014-0032028, filed on Mar. 19, 2014, entitled “CARBON-SILICON COMPOSITE, AND LITHIUM SECONDARY BATTERY ANODE AND LITHIUM SECONDARY BATTERY INCLUDING THE SAME”, which is hereby incorporated by reference in its entirety into this application.

### BACKGROUND

1. Technical Field

The present disclosure relates to a carbon-silicon composite, and a lithium secondary battery anode and a lithium secondary battery, which include the carbon-silicon composite.

2. Related Art

In order for lithium secondary batteries to be used as batteries for information technology (IT) devices and cars, the lithium secondary batteries require an anode material capable of realizing high capacity. As a high-capacity anode material for a lithium secondary battery, silicon is attracting attention. For example, pure silicon is known to have a high theoretical capacity of 4200 mAh/g.

However, silicon has inferior cycle characteristics compared to a carbon-based material, and thus has not yet been put to practical use. This is because if inorganic particles such as silicon are used as the anode active material to absorb and release lithium, the conductivity between the active material particles will be reduced due to a change in the volume during charge and discharge, or the anode active material will be peeled off from the anode current collector. Specifically, when inorganic particles, such as silicon particles, included in the anode active material, absorb lithium ions during charge, the volume expands by about 300-400%. In addition, when lithium ions are released during discharge, the inorganic particles shrink. When such charge/discharge cycles are repeated, electrical insulation may occur due to an empty space generated between the inorganic particles and the anode active material, resulting in a rapid decrease in the lifespan. Thus, the inorganic particles have a serious problem when they are used in lithium secondary batteries

### SUMMARY

An object of the present disclosure is to provide a carbon-silicon composite including: a first carbon matrix; and carbonized Si-block copolymer core-shell particles incorporated and dispersed in the first carbon matrix.

The objects of the present disclosure are not limited to the above-mentioned objects, and other objects not mentioned herein will be clearly understood by those skilled in the art from the following description.

In an aspect, the present disclosure provides a carbon-silicon composite including: a first carbon matrix; and carbonized Si-block copolymer core-shell particles incorporated and dispersed in the first carbon matrix.

The carbonized Si-block copolymer core-shell particles may be distributed throughout the internal of the carbon-silicon composite.

The carbon-silicon composite may include agglomerates of the carbonized Si-block copolymer core-shell particles, and agglomerates of the carbonized Si-block copolymer core-shell particles in the first carbon matrix may have a diameter of 20 μm or less.

The carbon-silicon composite may have a silicon-to-carbon mass ratio of 0.5:99.5 to 30:70.

The first carbon matrix may include crystalline carbon, amorphous carbon, or a combination thereof.

The first carbon matrix may include at least one selected from the group consisting of natural graphite, artificial graphite, soft carbon, hard carbon, pitch carbide, calcined coke, graphene, carbon nanotubes, and combinations thereof.

The carbonized Si-block copolymer core-shell particles may be formed by carbonization of Si-block copolymer core-shell particles including: a Si core; and a block copolymer shell which includes a block having relatively high affinity for Si and a block having relatively low affinity for Si and forms a spherical micelle structure around the Si core.

The block having relatively high affinity for Si may be polyacrylic acid, polyacrylate, polymethacrylic acid, polymethylmethacrylate, polyacrylamide, carboxymethyl cellulose, polyvinyl acetate, or polymaleic acid.

The block having relatively low affinity for Si may be polystyrene, polyacrylonitrile, polyphenol, polyethylene glycol, poly lauryl methacrylate, poly lauryl acrylate, or polyvinyl difluoride.

The particle diameter distribution of the Si-block copolymer core-shell particles in a slurry solution may satisfy the following condition:

2 nm<D50<120 nm

wherein D50 is the 50% cumulative mass-particle size distribution diameter of the Si-block copolymer core-shell particles.

The particle diameter distribution of the Si-block copolymer core-shell particles in a slurry solution may satisfy the following condition:

1≦D90/D50≦1.4

wherein D90 is the 90% cumulative mass-particle size distribution diameter of the Si-block copolymer core-shell particles, and D50 is the 50% cumulative mass-particle size distribution diameter of the Si-block copolymer core-shell particles.

The carbonized block copolymer shell particles may have a higher porosity than the first carbon matrix.

The carbonized block copolymer shell particles may have a carbonization yield of 5-30%.

The first carbon matrix may have a carbonization yield of 40-80%.

The carbon-silicon composite may further include second carbon particles.

The carbon-silicon composite may be spheronized together with the second carbon particles.

The carbon-silicon composite may further include amorphous carbon coating layer as the outermost layer.

In another aspect, the present disclosure provides a method for preparing a carbon-silicon composite, including the steps of: preparing a slurry solution containing Si-block copolymer core-shell particles; mixing the slurry solution with a carbon precursor to prepare a mixture solution; and subjecting the mixture solution to a carbonization process.

The carbon precursor may include a first carbon precursor and a second carbon precursor.

In still another aspect, the present disclosure provides an anode for a lithium secondary battery, which include an anode current collector coated with an anode slurry, the anode slurry including: the above-described carbon-silicon composite; a binder; and a thickener.

In yet another aspect, the present disclosure provides a lithium secondary battery including the above-described anode.

### BRIEF DESCRIPTION OF THE DRAWINGS

FIG. 1 is a graph showing the results of measuring the distribution characteristic of Si-block copolymer core-shell particles or Si particles in a slurry solution, used for the preparation of a carbon-silicon composite in Example 1 and Comparative Example 1, by dynamic light scattering (measurement device: ELS-Z2, manufactured by Otsuka Electronics).

FIG. 2 is a scanning electron microscope (SEM) image for a section of a lithium secondary battery anode by focused ion beam (FIB) fabricated using the silicon-carbon composite prepared in Example 1.

FIG. 3a and FIG. 3a show energy-dispersive spectroscopy (EDS) images of carbon (FIG. 3a) and silicon (FIG. 3b) in the silicon-carbon composite prepared in Example 1.

FIG. 4 is a graph showing discharge capacity as a function of cycle number for the lithium secondary battery fabricated in Example 1.

### DETAILED DESCRIPTION

Hereinafter, embodiments of the present disclosure will be described in detail. It is to be understood, however, that these examples are for illustrative purposes only and are not intended to limit the scope of the present disclosure as defined in the appended claims.

Carbon-Silicon Composite (1)

In an embodiment, the present disclosure provides a carbon-silicon composite (1) including: a first carbon matrix; and carbonized Si-block copolymer core-shell particles incorporated and dispersed in the first carbon matrix.

The carbon-silicon composite (1) is formed in such a manner that the carbonized Si-block copolymer core-shell particles are dispersed uniformly in the first carbon matrix while the carbonized Si-block copolymer core-shell particles do not agglomerate into larger particles during a process of forming the composite with the first carbon matrix. In this manner, the carbonized Si-block copolymer core-shell particles can be formed so that they are dispersed uniformly throughout the first carbon matrix of the carbon-silicon composite 1. When this carbon-silicon composite (1) is applied as an anode active material for a lithium secondary battery, it will effectively exhibiting the high capacity properties of silicon while solving the volume expansion problem during charge and discharge, thereby improving the lifespan characteristics of the lithium secondary battery.

The carbon-silicon composite (1) including the carbonized Si-block copolymer core-shell particles dispersed uniformly therein can exhibit higher charge capacity compared to a material containing the same amount of silicon. For example, it can exhibit a capacity corresponding to about 80% or more of the theoretical capacity of silicon.

Specifically, the carbon-silicon composite (1) may be formed in the form of spherical or nearly spherical particles, and may have a particle diameter ranging from 0.5 μm to 50 μm. When the carbon-silicon composite (1) having the particle size in this range is used as an anode active material for a lithium secondary battery, it can effectively exhibit charge capacity due to the high capacity properties of silicon while solving the volume expansion problem during charge and discharge, thereby improving the lifespan characteristics of the lithium secondary battery.

The carbon-silicon composite (1) may include silicon and carbon at a silicon-to-carbon mass ratio of 0.5:99.5 to 30:70. The carbon-silicon composite (1) has an advantage in that it may have a high content of silicon in the above mass ratio range. In addition, it can solve the volume expansion problem that can occur when silicon is used as an anode active material, because the carbonized Si-block copolymer core-shell particles are dispersed uniformly therein while a large amount of silicon is contained therein.

The first carbon matrix may be formed of crystalline carbon, amorphous carbon or a combination thereof.

Specifically, the first carbon matrix may include at least one selected from the group consisting of natural graphite, artificial graphite, soft carbon, hard carbon, pitch carbide, calcined coke, graphene, carbon nanotubes, and combinations thereof.

The carbon-silicon composite (1) has very low oxygen content, because it contains little or no oxide material that can reduce, for example, the performance of secondary batteries. Specifically, the carbon-silicon composite (1) may have an oxygen content of 0-1 wt %. In addition, the first carbon matrix is essentially composed of carbon without substantially containing impurities and byproduct compounds. Specifically, the content of carbon in the first carbon matrix may be 70-100 wt %.

The carbonized Si-block copolymer core-shell particles may be formed by carbonization of Si-block copolymer core-shell particles including: a Si core; and a block copolymer shell which includes a block having relatively high affinity for Si and a block having relatively low affinity for Si and forms a spherical micelle structure around the Si core.

The Si-block copolymer core-shell particles have a structure in which a block copolymer shell including a block having relatively high affinity for Si and a block having relatively low affinity for Si is coated on the surface of a Si core, and the block copolymer shell of the core-shell nanoparticles forms a spherical micelle structure, in which the blocks having relatively high affinity for Si are drawn toward the surface of the Si core and the blocks having relatively low affinity for Si are drawn toward the outside of the Si core by van der Waals forces or the like.

The weight ratio of the Si core to the block copolymer shell is preferably 2:1 to 1000:1, and more preferably 4:1 to 20:1, but is not limited thereto. If the weight ratio of the Si core to the block copolymer shell is less than 2:1, there will be a problem in that the amount of Si core that can be actually alloyed with lithium in an anode active material decreases, and thus the capacity of the anode active material and the efficiency of the lithium secondary battery decrease. Conversely, if the weight ratio of the Si core to the block copolymer shell is more than 1000:1, the content of the block copolymer shell decreases so that the dispersibility and stability thereof in a slurry solution will decrease, and thus the block copolymer shell of the carbonized core-shell particles cannot properly perform buffering action in an anode active material.

The block having relatively high affinity for Si is drawn toward the surface of the Si cores by van der Waals forces or the like. Herein, the block having relatively high affinity for Si is preferably polyacrylic acid, polyacrylate, polymethacrylic acid, polymethylmethacrylate, polyacrylamide, carboxymethyl cellulose, polyvinyl acetate, or polymaleic acid, but is not limited thereto.

The block having relatively low affinity for Si is drawn toward the outside of the Si core. Herein, block having relatively low affinity for Si is preferably polystyrene, polyacrylonitrile, polyphenol, polyethylene glycol, poly lauryl methacrylate, poly lauryl acrylate, or polyvinyl difluoride, but is not limited. The block having relatively low affinity for Si is characterized in that the carbonization yield thereof is higher than that of the block having relatively high affinity for Si.

Most preferably, the block copolymer shell is a polyacrylic acid-polystyrene block copolymer. Herein, the number-average molecular weight (Mn) of the polyacrylic acid is preferably 100-100,000 g/mol, and the number-average molecular weight (Mn) of the polystyrene is preferably 100-100,000 g/mol, but is not limited thereto.

The particle size distribution of the Si-block copolymer core-shell particles in a slurry solution preferably satisfies the following conditions: 1≦D90/D50≦1.4, and 2 nm<D50<120 nm, wherein D90 is the 90% cumulative mass-particle size distribution diameter of the Si-block copolymer core-shell particles in the slurry solution, and D50 is the 50% cumulative mass-particle size distribution diameter of the Si-block copolymer core-shell particles. However, the particle size distribution in the present disclosure is not limited thereto. As used herein, the term “slurry solution” refers to a slurry containing the Si-block copolymer core-shell particles and a dispersion medium. The block copolymer shell of the Si-block copolymer core-shell particles forms a spherical micelle structure around the Si core, and thus the Si-block copolymer core-shell particles will have excellent dispersibility compared to Si particles having no block copolymer. Accordingly, the agglomeration of the particles will be reduced, and thus the D50 of the particles in the slurry solution will be small while the difference in size between the particles will be small, suggesting that the particles will have a uniform particle size distribution. Therefore, the carbonized Si-block copolymer core-shell particles can be more uniformly dispersed in the first carbon matrix.

As described above, the carbon-silicon composite (1) are distributed throughout the internal of the first carbon matrix, and are present not only on the surface, but also internal of the first carbon matrix in a well dispersed state. Herein, “internal of the first carbon matrix in a well dispersed state” may mean that the carbonized Si-block copolymer core-shell particles are incorporated and present in a depth corresponding to 5% or more of the radius of the carbon-silicon composite (1). More specifically, the carbonized Si-block copolymer core-shell particles are present in a depth corresponding to 1-100% of the radius of the carbon-silicon composite (1). In this respect, the carbon-silicon composite (1) is distinguished from a carbon-silicon composite in which the carbonized Si-block copolymer core-shell particles are present only on the surface corresponding to 5% or less of the radius of the carbon-silicon composite. It is to be understood that “the carbonized Si-block copolymer core-shell particles are present in a depth corresponding to 1-100% of the carbon-silicon composite (1)” does not exclude “the carbonized Si-block copolymer core-shell particles are present in a depth corresponding to 0-1% of the carbon-silicon composite (1)”.

In addition, because the Si-block copolymer core-shell particles generally agglomerate together during a carbonization process, the carbon-silicon composite (1) may include agglomerates of the carbonized Si-block copolymer core-shell particles.

As used herein, “the carbonized Si-block copolymer core-shell particles are dispersed uniformly” means that the carbonized Si-block core-shell particles are distributed uniformly throughout the first carbon matrix. In addition, it means that agglomerates of the carbonized Si-block copolymer core-shell particles are uniformly formed, and thus the difference in diameter between agglomerates of the carbonized Si-block copolymer core-shell particles is insignificant in terms of statistical analysis. Specifically, it means that the maximum value of the diameter of agglomerates of the carbonized Si-block copolymer core-shell particles is lower than a critical level.

In other words, because the carbonized Si-block copolymer core-shell particles in the carbon-silicon composite are sufficiently dispersed, agglomerates of the carbonized Si-block copolymer core-shell particles also become smaller in size. Specifically, agglomerates of the carbonized Si-block copolymer core-shell particles in the carbon-silicon composite may be formed to have a diameter of 20 μm or less.

For example, agglomerates of the carbonized Si-block copolymer core-shell particles in the carbon-silicon composite (1) may have an average diameter of 10-20 μm.

In addition, the block copolymer shell particles may have a higher porosity than the first carbon matrix composed essentially of carbon, because impurities (e.g., oxygen or hydrogen) and byproduct compounds in the block copolymer shell particles are evaporated without being carbonized during a carbonization process, and pores remain after the evaporation of the impurities (e.g., oxygen or hydrogen) and byproduct compounds.

In addition, the carbonization yield of the block copolymer shell particles is preferably 5-30%, and the carbonization yield of the first carbon matrix is preferably 40-80%, but is not limited thereto. The first carbon matrix is essentially composed of carbon without substantially containing impurities and byproduct compounds, and thus has a significantly high carbonization yield. Conversely, the carbonized block copolymer shell particles contain impurities (e.g., oxygen or hydrogen) and byproduct compounds, and thus have a low carbonization yield.

As used herein, the term “particle diameter” may mean the distance between two points, which is defined when a straight line passing through the center of gravity of the particle meets the surface of the particle.

The particle diameter can be measured according to various known methods. For example, it can be measured by using X-ray diffraction (XRD) or analyzing a scanning electron microscope (SEM) image.

Hereinafter, a method for preparing the carbon-silicon composite (1) will be described in detail.

The method for preparing the carbon-silicon composite (1) may include the steps of: preparing a slurry solution containing Si-block copolymer core-shell particles; mixing the slurry solution with a carbon precursor to prepare a mixture solution; and subjecting the mixture solution to a carbonization process.

According to the method for preparing the carbon-silicon composite (1), a carbon-silicon composite (1) as described above can be formed, which include: a first carbon matrix; and carbonized Si-block copolymer core-shell particles dispersed uniformly in the first carbon matrix. Specifically, according to the method for preparing the carbon-silicon composite (1), a carbon-silicon composite can be prepared, in which carbonized Si-block copolymer core-shell nanoparticles are dispersed uniformly throughout the first carbon matrix in the carbon-silicon composite (1).

In the method for preparing the carbon-silicon composite (1), the above-described carbon-silicon composite (1) including carbonized Si-block copolymer core-shell nanoparticles dispersed uniformly throughout the carbon-silicon composite (1) can be formed by using the slurry solution prepared by well dispersing Si-block copolymer core-shell particles before mixing with a carbon precursor.

The Si-block copolymer core-shell particles have a uniform particle size distribution with a small difference in size between the particles while the D50 value thereof in the slurry solution is small. The Si-block copolymer core-shell particles can be more uniformly dispersed in the first carbon matrix compared to Si particles having no block copolymer, because the block copolymer shell of the Si-block copolymer core-shell particles forms a spherical micelle structure around the Si core.

When the carbon-silicon composite (1), prepared from the slurry solution containing the Si-block copolymer core-shell nanoparticles dispersed uniformly therein, are used as an anode active material for a lithium secondary battery, it can solve the volume expansion problem during charge and discharge, and thus improve the lifespan characteristics of the lithium secondary battery.

The slurry solution containing the Si-block copolymer core-shell particles has an advantage in that it can inhibit the oxidation of silicon (Si), because the Si-block copolymer core-shell particles dispersed uniformly in the slurry solution are used in a slurry state in which they are dispersed in a dispersion medium, so that the silicon particles will not be exposed to air, unlike powdery silicon that is exposed to air. Because the oxidation of silicon is inhibited, the capacity of silicon can further be increased when the carbon-silicon composite (1) is used as an anode active material for a lithium secondary battery, thereby further improving the electrical properties of the lithium secondary battery.

Hereinafter, the slurry solution containing the Si-block copolymer core-shell particles will be described in detail.

The slurry solution containing the Si-block copolymer core-shell particles has a high content of silicon particles, while it can satisfy the following dispersion conditions: about 1≦D90/D50≦1.4, and about 2 nm<D50<120 nm. In addition, because it is used in a slurry state, it has a high content of silicon particles, while the silicon particles have a small particle size and can be well maintained in a uniformly dispersed state.

To make a slurry solution containing the Si-block copolymer core-shell particles, which satisfies the above described dispersion conditions: about 1≦D90/D50≦1.4 and about 2 nm<D50<120 nm, various methods for enhancing dispersion may be used. Particularly, to make a slurry solution, which satisfies the above dispersion conditions, using silicon powder having a relatively large particle diameter, a combination of various methods may be performed or applied.

Examples of the method for enhancing dispersion include controlling the kind of dispersion medium, adding an additive for enhancing dispersion to a slurry solution, sonicating a slurry solution, etc. In addition to these methods for enhancing dispersion, various known methods can be used alone or in combination.

The dispersion medium may include one selected from the group consisting of N-methyl-2-pyrrolidone (NMP), tetrahydrofuran (THF), water, ethanol, methanol, cyclohexanol, cyclohexanone, methyl ethyl ketone, acetone, ethylene glycol, octanol, diethyl carbonate, dimethyl sulfoxide (DMSO), and combinations thereof.

The use of the dispersion medium can facilitate the dispersion of the slurry solution containing the Si-block copolymer core-shell particles.

In order to satisfy the above-described dispersion conditions, the slurry solution containing the Si-block copolymer core-shell particles is preferably subjected to various processes using a sonicator, a fine mill, a ball mill, a three-roll mill, a stamp mill, an eddy mill, a homo-mixer, a planetary centrifugal mixer, a homogenizer or a vibration shaker. More preferably, the slurry solution is sonicated, but is not limited thereto.

Specifically, the sonication process may be performed either by a batch type process in which the slurry solution is simultaneously sonicated, or by a continuous type process in which the slurry solution is circulated so that a portion of the slurry solution is continuously sonicated.

A device for performing the sonication process generally has a tip. When this device is used, silicon particles are dispersed using ultrasonic energy emitted from the tip, and there is a limit to the area to which this ultrasonic energy is transferred. Thus, when a large amount of the slurry solution is to be sonicated, the slurry solution is preferably sonicated by the continuous type process in which the slurry solution is circulated so that a portion of the slurry solution is continuously sonicated. The efficiency of sonication in the continuous type process can be increased compared to that in the batch-type process. In other words, when the continuous type process is used, a larger amount of the slurry solution can be sonicated within the same time using the same power as those for the batch-type process.

In a specific example, when the sonication is performed by the batch-type process, 1000 ml or less of the slurry solution can be sonicated using a power supply of 100-500 Watt for 30 seconds to 1 hour.

In another specific example, when the sonication is performed by the continuous type process, about 3600 ml/hr of the slurry solution can be sonicated using a power supply of 500 Watt for 30 seconds to 1 hour.

In still another specific example, the sonication can be performed using ultrasonic waves at a frequency of 10-100 kHz, but is not limited thereto.

If the slurry solution is prepared by simply mixing silicon power with a dispersion medium, the silicon particles will agglomerate, and for this reason, the average diameter of the silicon particles in the slurry solution will increase, and the silicon particles will not be dispersed uniformly.

However, as described above, when an additional process for enhancing dispersion for example, a process of selecting a suitable kind of dispersion solvent or a process of performing sonication, is used to facilitate dispersion, a slurry solution satisfying the following distribution conditions can be prepared using silicon particles: about 1≦D90/D50≦1.4, and about 2 nm<D50<120 nm. In other words, even when silicon powder having an average particle diameter of about 2-200 nm, particularly about 60-150 nm, is used, a slurry solution containing silicon particles dispersed uniformly in a dispersion medium can be obtained.

After the slurry solution is prepared as described above, it is mixed with a carbon precursor to prepare a mixture solution containing the carbon precursor dissolved in the slurry solution.

The dispersion medium of the slurry solution can dissolve the carbon precursor. Thus, the carbon precursor can be dissolved in the slurry solution to prepare a mixture solution.

Because the carbon precursor is dissolved in the silicon slurry solution, it can be carbonized in a subsequent carbonization process in a state in which the Si-block copolymer core-shell particles are incorporated therein, thereby forming a carbon-silicon composite (1) containing carbonized Si-block copolymer core-shell particles, incorporated and dispersed in the carbon matrix.

The carbon precursor may include at least one selected from the group consisting of natural graphite, artificial graphite, soft carbon, hard carbon, pitch, coke, graphene, carbon nanotubes, and combinations thereof. Specifically, the carbon precursor that is used herein may be commercially available coal-based pitch or petroleum-based pitch.

The carbon precursor is carbonized by a subsequent carbonization process to form a carbon matrix containing crystalline carbon, amorphous carbon or a combination thereof.

The carbon precursor that is used herein may be conductive or non-conductive.

Specific examples of the dispersion medium are as described above.

The slurry solution may be mixed with the carbon precursor so that the silicon-to-carbon mass ratio of the mixture solution will be 0.5:99.5 to 30:70. The slurry solution and the carbon precursor are mixed in suitable amounts so that the mixture solution will contain silicon and carbon in the above mass ratio range. When the carbon-silicon composite (1) prepared using the mixture solution containing silicon and carbon in the above mass ratio range is used as an anode active material for a lithium secondary battery, it can effectively exhibit the high capacity properties of silicon while solving the volume expansion problem during charge and discharge to improve the lifespan characteristics of the lithium secondary battery.

After the mixture solution is prepared as described above, it is subjected to a carbonization process to prepare a carbon-silicon composite (1).

As used herein, the term “carbonization process” means a process in which the carbon precursor is calcined at high temperature so that carbon remains as an inorganic material. In the carbonization process, the carbon precursor forms the first carbon matrix.

The carbonization process may be performed by heat-treating the mixture solution at a temperature of 400 to 1400° C. It may be performed at a pressure of 1-15 bar according to the intended use. In addition, it may be performed for 1-24 hours.

The carbonization process may be performed in a single step or multiple steps according to the intended use.

For example, the carbonization yield of the carbonization process may be 40-80 wt %. When the carbonization yield of the carbonization process in the method for preparing the carbon-silicon composite is increased, the generation of volatile components can be reduced and these volatile components can be easily treated. Thus, the carbonization process can be performed in an environmentally friendly manner.

Carbon-Silicon Composite (2)

The present disclosure also provides a carbon-silicon composite (2) including: the above-described carbon-silicon composite (1); and second carbon particles.

The carbon-silicon composite (2) includes: the carbon-silicon composite (1) is formed in such a manner that the carbonized Si-block copolymer core-shell particles are dispersed uniformly in the first carbon matrix while the carbonized Si-block copolymer core-shell particles do not agglomerate into larger particles during a process of forming the composite with the first carbon matrix; and second carbon particles.

The carbon-silicon composite (1) is formed in the form of spherical or nearly spherical particles. It is spheronized together with the second carbon particles, thereby forming the carbon-silicon composite (2). To spheronize the carbon-silicon composite (1) and the second carbon particles, various known methods and devices can be used.

The carbon-silicon composite (2) formed by spheronizing the carbon-silicon composite (1) and the second carbon particles may include pores formed between the carbon-silicon composite (1) and the second carbon particles.

The carbonized Si-block copolymer core-shell particles are dispersed uniformly in the carbon-silicon composite (1), while the silicon particles are dispersed uniformly throughout the carbon-silicon composite (2).

As described above, the carbonized Si-block copolymer core-shell particles are dispersed uniformly throughout the carbon-silicon composite (2). Thus, when the carbon-silicon composite (2) is used as an anode active material for a lithium secondary battery, it can effectively exhibit the high capacity properties of silicon while solving the volume expansion problem during charge and discharge to thereby improve the lifespan characteristics of the lithium secondary battery.

The carbon-silicon composite (2) including the carbonized Si-block copolymer core-shell particles dispersed uniformly therein can exhibit higher capacity compared to a material having the same silicon content. For example, it can exhibit a capacity corresponding to about 80% or more of the theoretical capacity of silicon.

The carbon-silicon composite (2) may be formed in the form of spherical or nearly spherical particles, and may have a particle diameter of 0.5-50 μm. When the carbon-silicon composite (2) having a particle size in the above range is used as an anode active material for a lithium secondary battery, it can effectively exhibit the high capacity properties of silicon while solving the volume expansion problem during charge and discharge to thereby improve the lifespan characteristics of the lithium secondary battery.

The first carbon matrix may include at least one selected from the group consisting of pitch carbide, polymer carbide and a combination thereof.

The second carbon particles may include at least one selected from the group consisting of natural graphite, artificial graphite, soft carbon, hard carbon, pitch carbide, calcined coke, graphene, carbon nanotubes, and combinations thereof.

Specifically, in the carbon-silicon composite (2), the first carbon matrix may be amorphous carbon, and the second carbon particles may be crystalline carbon. For example, when the second carbon particles are graphite particles, they can have a lamellar or flake shape, and can be spheronized together with the spherical carbon-silicon composite (1), thereby forming the carbon-silicon composite (2) including the spherical carbon-silicon composite (1) incorporated and dispersed between layers of the second carbon particles.

The carbon-silicon composite (2) has a very low oxygen content, because it contains little or no oxide material that can degrade, for example, the performance of secondary batteries. Specifically, the carbon-silicon composite (2) may have an oxygen content of 0-1 wt %. In addition, the first carbon matrix is essentially composed of carbon without substantially containing impurities and byproduct compounds. Specifically, the content of carbon in the first carbon matrix may be 70-100 wt %.

The carbon-silicon composite (2) may further include an amorphous carbon coating layer as the outermost layer.

When the second carbon particles are graphite particles, they may have a lamellar or flake shape, and have an average diameter of 0.5-500 μm and a lamellar thickness of 0.01-100 μm.

In detail, the carbon-silicon composite (1) may be 0.5-50 μm.

The carbonized Si-block copolymer core-shell particles included in the carbon-silicon composite (2) are as described above with respect to the carbonized Si-block copolymer core-shell particles included in the carbon-silicon composite (1).

Hereinafter, a method for preparing the carbon-silicon composite (2) will be described in detail.

The method for preparing the carbon-silicon composite (2) may include the steps of: preparing a slurry solution containing Si-block copolymer core-shell particles; mixing the slurry solution with a first carbon precursor and a second carbon precursor to prepare a mixture solution; and subjecting the mixture solution to a carbonization process.

Herein, the method may further include spheronizing the carbon-silicon composite.

In the mixture solution, the first carbon precursor is dissolved in the dispersion medium of the slurry solution, and the second carbon precursor is insoluble in the dispersion medium. For this reason, when the mixture solution is subjected to the carbonization process, a carbon-silicon composite (1) including carbonized Si-block copolymer core-shell particles, incorporated and dispersed in the first carbon matrix, is formed, and the second carbon precursor forms separate second carbon particles. As a result, the carbon-silicon composite (2) having the above-described structure can be formed.

According to the method for preparing the carbon-silicon composite, the carbon-silicon composite (2) can be prepared, in which the carbonized Si-block copolymer core-shell nanoparticles are dispersed uniformly throughout the first carbon matrix in the carbon-silicon composite, and thus the carbonized Si-block copolymer core-shell particles are dispersed uniformly throughout the carbon-silicon composite (2).

According to the method for preparing the carbon-silicon composite (2), the carbon-silicon composite (2) including the carbonized Si-block copolymer core-shell nanoparticles, dispersed and distributed uniformly throughout the first carbon matrix and the carbon-silicon composite (2), can be formed by using a slurry solution of Si-block copolymer core-shell particles, prepared by well dispersing Si-block copolymer core-shell particles before mixing with the first carbon precursor and the second carbon precursor.

The slurry solution containing the Si-block copolymer core-shell particles, which is used to prepare the carbon-silicon composite (2), is as described above with respect to the slurry solution containing the Si-block copolymer core-shell particles, which is used to prepare the carbon-silicon composite (1).

After the slurry solution is prepared as described above, it is mixed with the first carbon precursor and the second carbon precursor to prepare a mixture solution containing the first carbon precursor dissolved in the slurry solution. The dispersion medium of the slurry solution can dissolved the first carbon precursor, and the second carbon precursor is not dissolved in the dispersion medium of the slurry solution.

The first carbon precursor may include at least one selected from the group consisting of pitch, polymers, and combinations thereof.

The second carbon precursor may include at least one selected from the group consisting of natural graphite, artificial graphite, soft carbon, pitch, graphene, carbon nanotubes, and combinations thereof.

When pitch is used as the first carbon precursor or the second carbon precursor, it may be commercially available coal tar-based pitch or petroleum-based pitch. Specifically, amorphous carbon material may be used as the first carbon precursor, and crystalline carbon material may be used as the second carbon precursor.

The carbon precursors are carbonized in a subsequent carbonization process to form the first carbon matrix and the second carbon particles, respectively. Herein, because the first carbon precursor and the second carbon precursor are dissolved in the mixture solution, the carbonized Si-block copolymer core-shell particles are dispersed therein to form the carbon-silicon composite (2).

The first carbon precursor and the second carbon precursor, which are used in the present disclosure, may be conductive or non-conductive.

Specific examples of the dispersion medium are as described above.

The contents of the first carbon and the second carbon in the mixture solution are as described above. The slurry solution containing the Si-block copolymer core-shell particles may be suitably mixed with the first carbon precursor and the second carbon precursor so that the carbon-silicon composite can be formed.

After the mixture solution is prepared as described above, it is subjected to a carbonization process to prepare a mixture of the carbon-silicon composite (1) and the second carbon particles.

The carbonization process used in the method for preparing the carbon-silicon composite (2) is as described above with respect to the carbonization process used in the method for preparing the carbon-silicon composite (1).

Then, the mixture of the carbon-silicon composite (1) and the second carbon particles may be spheronized. This spheronization process may be performed using various known methods and devices. The spheronized carbon-silicon composite may include pores formed between the carbon-silicon composite (1) and the second carbon particles. In addition, the carbon-silicon composite may include pores formed by the evaporation of a solvent during the above-described carbonization process.

The preparation method may further include a step of coating the spheronized carbon-silicon composite with amorphous carbon precursor and carbonating the coated precursor to form amorphous carbon coating layer.

Anode for Lithium Secondary Battery

The present disclosure provides an anode for a lithium secondary battery, which includes an anode current collector coated with an anode slurry including: the carbon-silicon composite; a binder; and a thickener.

The anode for the lithium secondary battery is formed by coating an anode current collector with an anode slurry including the carbon-silicon composite, a binder and a thickener, and drying and rolling the coated anode current collector.

The binder that is used in the present disclosure may be selected from among various binder polymers, including styrene butadiene rubber (SBR), carboxymethyl cellulose (CMC), a polyvinylidene fluoride-hexafluoropropylene copolymer (PVDF-co-HFP), polyvinylidene fluoride, polyacrylonitrile, and polymethylmethacrylate. The thickener is used to control viscosity, and may be selected from among carboxymethyl cellulose, hydroxymethyl cellulose, hydroxyethyl cellulose and hydroxypropyl cellulose.

The anode current collector may be made of stainless steel, nickel, copper, titanium, or an alloy thereof. Preferably, it is made of copper or a copper alloy.

Lithium Secondary Battery

The present disclosure provides a lithium secondary battery including the lithium secondary battery anode as described above.

The lithium secondary battery includes, as an anode active material, the above-described carbon-silicon composite including carbonized Si-block copolymer core-shell nanoparticles dispersed uniformly therein, and thus has improved charge capacity and lifespan characteristics.

The lithium secondary battery includes: the lithium secondary battery anode as described above; a cathode including a cathode active material; a separator; and an electrolyte.

The cathode active material may be a compound capable of absorbing and releasing lithium, such as LiMn₂O₄, LiCoO₂, LiNiO₂ or LiFeO₂.

The separator is interposed between the anode and the cathode to provide insulation therebetween, and may be made of an olefinic porous film such as a polyethylene or polypropylene film.

In addition, the electrolyte that is used in the present disclosure may be a solution of one or more lithium salts, selected from among LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN (CₓF₂ₓ₊₁SO₂)(C_{y}F_{2y+1}SO₂) (x and y: natural number), LiCl, LiI and the like, in one or more aprotic solvents selected from among propylene carbonate, ethylene carbonate, butylene carbonate, benzonitrile, acetonitrile, tetrahydrofuran, 2-methyltetrahydrofuran, γ-butyrolactone, dioxolane, 4-methyl dioxolane, N,N-dimethylformamide, dimethylacetamide, dimethylsulfoxide, dioxane, 1,2-dimethoxyethane, sulfolane, dichloroethane, chlorobenzene, nitrobenzene, dimethyl carbonate, methyl ethyl carbonate, diethyl carbonate, methyl propyl carbonate, methyl isopropyl carbonate, ethyl propyl carbonate, dipropyl carbonate, diisopropyl carbonate, dibutyl carbonate, diethylene glycol and dimethyl ether.

In addition, a medium- or large-sized battery module or battery pack may be provided by a plurality of the lithium secondary batteries that can be connected to one another. The medium- or large-sized battery module or battery pack may be used as a medium- or large-sized device power supply for at least one selected from among: power tools; electric vehicles including electric vehicles (EVs), hybrid electric vehicles (HEVs), and plug-in hybrid electric vehicles (PHEVs); electric trucks; commercial electric vehicles; and power storage systems.

Hereinafter, the present disclosure will be described in detail with reference to examples. It is to be understood, however, that these examples are for illustrative purposes only and are not intended to limit the scope of the present disclosure.

### EXAMPLES

### Example 1

### Preparation of Silicon-Carbon Composite (1)

A polyacrylic acid-polystyrene block copolymer was prepared from polyacrylic acid and polystyrene by method of reversible addition fragmentation chain transfer. Here, the polyacrylic acid had a number average molecular weight (Mₙ) of 4090 g/mol, and the polystyrene had a number average molecular weight (Mₙ) of 29370 g/mol.

0.1 g of the polyacrylic acid-polystyrene block copolymer was mixed with 8.9 g of N-methyl-2-pyrrolidone (NMP). 1 g of Si particles having an average particle diameter of 50 nm were added to 9 g of the mixture solution. The mixed solution to which the Si particles had been added was sonicated using an ultrasonic horn at 20 kHz for 10 minutes, thereby preparing a slurry solution containing core-shell nanoparticles.

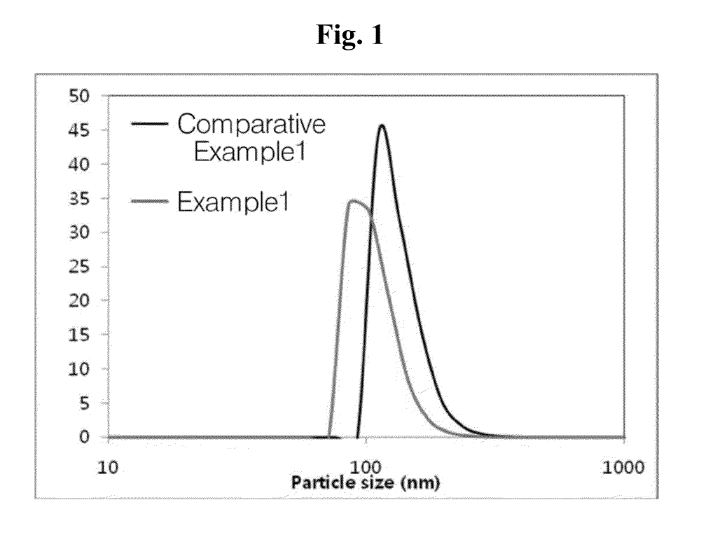

The distribution characteristic of the Si-copolymer core-shell particles in the slurry solution containing the Si-copolymer core-shell particles was measured by dynamic light scattering (measurement device: ELS-Z2, manufactured by Otsuka Electronics). As a result, as shown in FIG. 1, D50 was 92.8, and D90/D50 was 126.8/92.8=1.37.

Coal-based pitch that evaporated at 350° C. was mixed with the prepared slurry solution containing the Si-block copolymer core-shell particles, followed by stirring for about 30 minutes, thereby preparing a mixture solution containing the coal-based pitch dissolved in the NMP dispersion medium. Herein, the coal-based pitch and the Si-block copolymer core-shell particles were mixed at a weight ratio of 97.5:2.5. The NMP dispersion medium was evaporated under a vacuum at 110 to 120° C. Then, the resulting material was heated at a rate of 10° C./min and carbonized at 900° C. for 5 hours, thereby forming a silicon-carbon composite. The formed silicon-carbon composite was subjected to planetary ball milling at 220 rpm for 1 hour, and then sieved to obtain powder having a particle size of 20-50 μm.

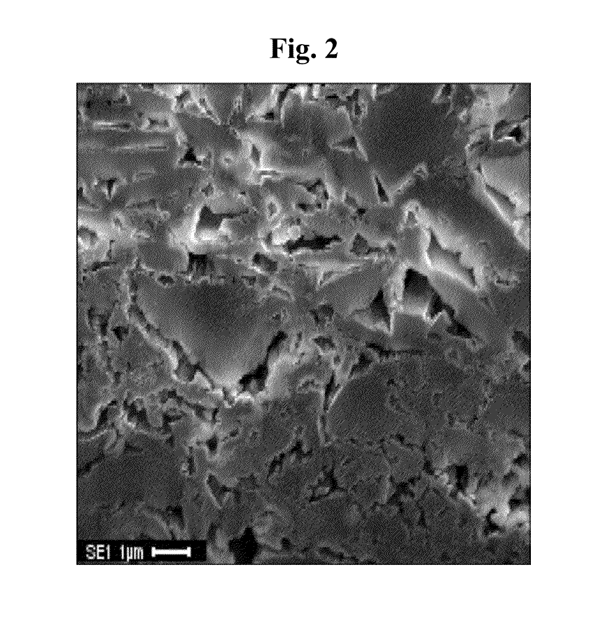

The obtained silicon-carbon composite sample was sectioned by a FIB (focused ion beam), and observed with a scanning electron microscope (SEM). As a result, as can be seen in FIG. 2, the carbonized Si-block copolymer core-shell particles were dispersed uniformly throughout the internal of the first carbon matrix.

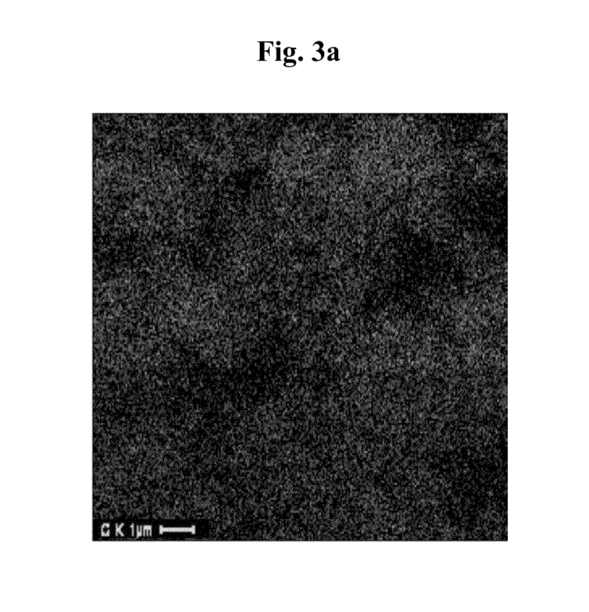

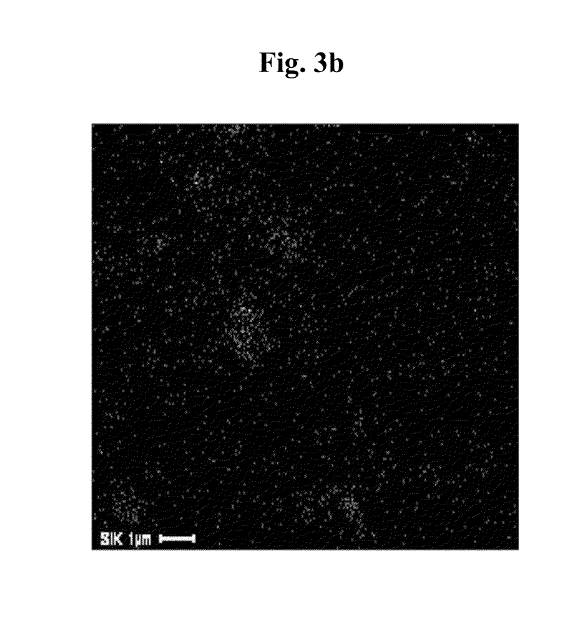

In addition, the silicon-carbon composite was analyzed by energy dispersive spectroscopy. As a result, as can be seen in FIG. 3, the silicon-carbon composite included silicon and carbon at a weight ratio of Si:C=97.9:2.1, particularly Si:C=99.65:1.35.

Fabrication of Anode for Lithium Secondary Battery

Using the silicon-carbon composite powder as an anode active material, the anode active material, carboxymethyl cellulose (CMC) and styrene butadiene rubber (SBR) were mixed at a weight ratio of 96:2:2 in water to prepare an anode slurry composition. The slurry composition was coated on a copper current collector, and dried in an oven at 110° C. for about 20 minutes, followed by rolling, thereby fabricating an anode for a lithium secondary battery.

Fabrication of Lithium Secondary Battery

The lithium secondary battery anode fabricated as described above, a separator, an electrolyte (containing 1.0M LiPF₆ in a mixed solvent in ethylene carbonate: dimethyl carbonate (1:1 w/w)) and a lithium electrode were sequentially deposited to fabricate a coin cell-type lithium secondary battery.

### Comparative Example 1

A lithium secondary battery was fabricated in the same manner as described in Example 1, except that a slurry solution containing Si particles without containing the polyacrylic acid-polystyrene block copolymer, was used.

The distribution characteristic of Si particles in the slurry solution containing Si particles was measured by dynamic light scattering (measurement device: ELS-Z2, manufactured by Otsuka Electronics). As a result, as shown in FIG. 1, D50 was 132.8, and D90/D50 was 188/132.8=1.42.

### Comparative Example 2

A lithium secondary battery was fabricated in the same manner as described in Example 1, except that an anode material made of soft carbon without containing Si was used.

### Test Example

The lithium secondary batteries, fabricated in Example 1 and Comparative Examples 1 and 2, were subjected to a charge/discharge test under the following conditions.

When 1 C was assumed to be 300 mA/g, each of the batteries was charged at a constant current of 0.2 C to 0.01 V and a constant voltage of 0.01 V to 0.01 C, and discharged at a constant current of 0.2 C to 1.5 V.

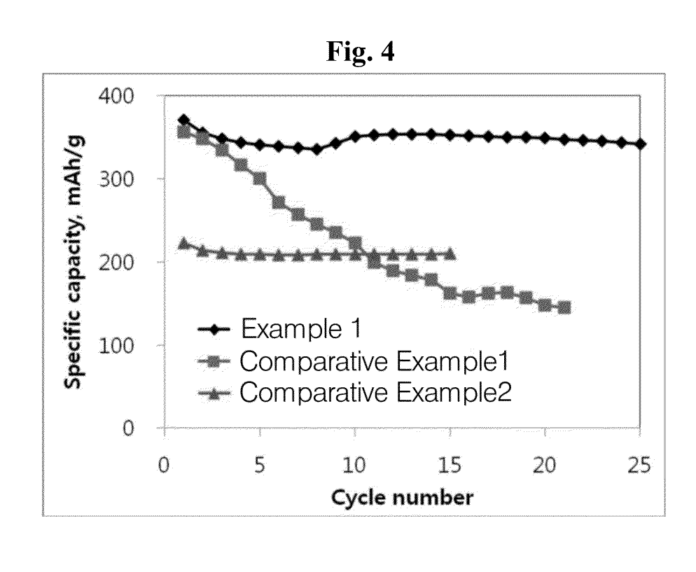

FIG. 4 is a graph showing the results of measuring discharge capacity as a function of cycle number for the lithium secondary batteries fabricated in Example 1 and Comparative Examples 1 and 2.

The results of measurement of the initial charge capacity (mAh/g), and the results of the charge capacity maintenance ratio (%) after 15 cycles relative to the initial charge capacity, are shown in Table 1 below.

TABLE 1

| | | Comparative | Comparative |
|---|---|---|---|
| | Example 1 | Example 1 | Example 2 |
| Initial charge | 351 | 356 | 223 |
| capacity | | | |
| (mAh/g) | | | |
| Charge capacity | 95.1 | 45.5 | 98.3 |
| maintenance | | | |
| ratio (%) after | | | |
| 15 cycles | | | |

As can be seen in FIG. 4 and Table 1 above, the lithium secondary battery fabricated in Example 1 using, as the anode active material, the carbon-silicon composite containing the carbonized Si-block copolymer core-shell particles, showed a significantly high charge capacity due to high-capacity silicon, and, at the same time, showed a high charge capacity maintenance ratio after 15 cycles. However, the lithium secondary battery fabricated in Comparative Example 1 showed a significant reduction in charge capacity after 15 cycles, and thus showed the capacity reduction problem which generally occurs when silicon is used.

Meanwhile, it could be seen that the lithium secondary battery fabricated in Comparative Example 2 did not show the capacity reduction problem caused by repeated charge cycles, because it did not include silicon, but the initial charge capacity thereof was significantly lower than those of Example 1 and Comparative Example 1.

As described above, the carbon-silicon composite according to the present disclosure includes carbonized Si-block copolymer core-shell particles dispersed uniformly therein. Thus, when it is used as an anode active material for a lithium secondary battery, it can further improve the charge capacity and lifespan characteristics of the lithium secondary battery.

While various embodiments have been described above, it will be understood to those skilled in the art that the embodiments described are by way of example only. Accordingly, the disclosure described herein should not be limited based on the described embodiments.

What is claimed is:

1. A carbon-silicon composite comprising: a first carbon matrix; and carbonized Si-block copolymer core-shell particles incorporated and dispersed in the first carbon matrix.

2. The carbon-silicon composite of claim 1, wherein the carbonized Si-block copolymer core-shell particles are distributed throughout an internal of the carbon-silicon composite.

3. The carbon-silicon composite of claim 1, which comprises agglomerates of the carbonized Si-block copolymer core-shell particles, and in which agglomerates of the carbonized Si-block copolymer core-shell particles in the first carbon matrix have a diameter of 20 μm or less.

4. The carbon-silicon composite of claim 1, which has a silicon-to-carbon mass ratio of 0.5:99.5 to 30:70.

5. The carbon-silicon composite of claim 1, wherein the first carbon matrix comprises crystalline carbon, amorphous carbon, or a combination thereof.

6. The carbon-silicon composite of claim 1, wherein the first carbon matrix comprises at least one selected from the group consisting of natural graphite, artificial graphite, soft carbon, hard carbon, pitch carbide, calcined coke, graphene, carbon nanotubes, and combinations thereof.

7. The carbon-silicon composite of claim 1, wherein the carbonized Si-block copolymer core-shell particles is formed by carbonization of Si-block copolymer core-shell particles comprising: a Si core; and a block copolymer shell which comprises a block having relatively high affinity for Si and a block having relatively low affinity for Si and forms a spherical micelle structure around the Si core.

8. The carbon-silicon composite of claim 7, wherein the block having relatively high affinity for Si is polyacrylic acid, polyacrylate, polymethacrylic acid, polymethylmethacrylate, polyacrylamide, carboxymethyl cellulose, polyvinyl acetate, or polymaleic acid.

9. The carbon-silicon composite of claim 7, wherein the block having relatively low affinity for Si is polystyrene, polyacrylonitrile, polyphenol, polyethylene glycol, poly lauryl methacrylate, poly lauryl acrylate, or polyvinyl difluoride.

10. The carbon-silicon composite of claim 7, wherein the particle diameter distribution of the Si-block copolymer core-shell particles in a slurry solution satisfies the following condition:
2 nm<D50<120 nm
wherein D50 is the 50% cumulative mass-particle size distribution diameter of the Si-block copolymer core-shell particles.

11. The carbon-silicon composite of claim 7, wherein the particle diameter distribution of the Si-block copolymer core-shell particles in a slurry solution satisfies the following condition:
1≦D90/D50≦1.4
wherein D90 is the 90% cumulative mass-particle size distribution diameter of the Si-block copolymer core-shell particles, and D50 is the 50% cumulative mass-particle size distribution diameter of the Si-block copolymer core-shell particles.

12. The carbon-silicon composite of claim 1, wherein the carbonized block copolymer shell particles have a higher porosity than the first carbon matrix.

13. The carbon-silicon composite of claim 1, wherein the carbonized block copolymer shell particles have a carbonization yield of 5-30%.

14. The carbon-silicon composite of claim 1, wherein the first carbon matrix has a carbonization yield of 40-80%.

15. The carbon-silicon composite of claim 1, further comprising second carbon particles.

16. The carbon-silicon composite of claim 15, wherein the second carbon particles are spheronized together with the carbon-silicon composite.

17. The carbon-silicon composite of claim 15, further comprising amorphous carbon coating layer as an outermost layer.

18. A method for preparing a carbon-silicon composite, comprising the steps of:
preparing a slurry solution containing Si-block copolymer core-shell particles;
mixing the slurry solution with a carbon precursor to prepare a mixture solution; and
subjecting the mixture solution to a carbonization process.

19. The method of claim 18, wherein the carbon precursor includes a first carbon precursor and a second carbon precursor.

20. An anode for a lithium secondary battery, which comprises an anode current collector coated with an anode slurry, the anode slurry comprising: a carbon-silicon composite according to claim 1; a binder; and a thickener.
